(19) United States
(12) Patent Application Publication
(10) Pub. No.: US 2011/0211730 A1
(43) Pub. Date: Sep. 1, 2011

(54) IMAGE MEASURING DEVICE FOR CALIBRATION TEST AND METHOD THEREOF

(75) Inventors: CHIH-KUANG CHANG, Tu-Cheng (TW); YONG-HONG DING, Shenzhen City (CN); XIAN-YI CHEN, Shenzhen City (CN); LI JIANG, Shenzhen City (CN); DONG-HAI LI, Shenzhen City (CN)

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/955,935

(22) Filed: Nov. 30, 2010

(30) Foreign Application Priority Data
Feb. 26, 2010 (CN) 201010114989.0

(51) Int. Cl. G06K 9/00

(52) U.S. Cl. 382/106

(57) ABSTRACT

An image measuring device comprises a storage, a processor, an acquiring module, a positioning module and a determining module. The acquiring module acquires an image of a production object by scanning the production object. The positioning module positions the image of the production object in a coordinate plane according to predefined parameters and acquiring the edge of the image of the production object. The determining module determines whether the difference between the positioned image and the predefined parameters is over a tolerance, wherein the acquiring module, the positioning module and the determining module are stored in the storage and controlled by the processor.

### BACKGROUND

1. Technical Field

The present disclosure relates to image measuring devices, and more particularly to an image measuring device test and method thereof.

2. Description of Related Art

Production yield is much more important in massive production process since Original Equipment Manufacturing industry is highly competitive. Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a block diagram of an exemplary embodiment of an image measuring device for calibration test of the present disclosure.

FIG. 2 is a block diagram of an exemplary embodiment of the processing module of the present disclosure.

FIG. 3 is a flowchart of an exemplary embodiment of a measuring method for calibration test of the present disclosure.

### DETAILED DESCRIPTION

In general, the word “module” as used herein, refers to logic embodied in hardware or firmware, or to a collection of software instructions, written in a programming language, such as, for example, Java, C, or assembly. One or more software instructions in the unit may be integrated in firmware, such as an EPROM. It will be appreciated that module may comprise connected logic units, such as gates and flip-flops, and may comprise programmable units, such as programmable gate arrays or processors. The unit described herein may be implemented as either software and/or hardware unit and may be stored in any type of computer-readable medium or other computer storage device.

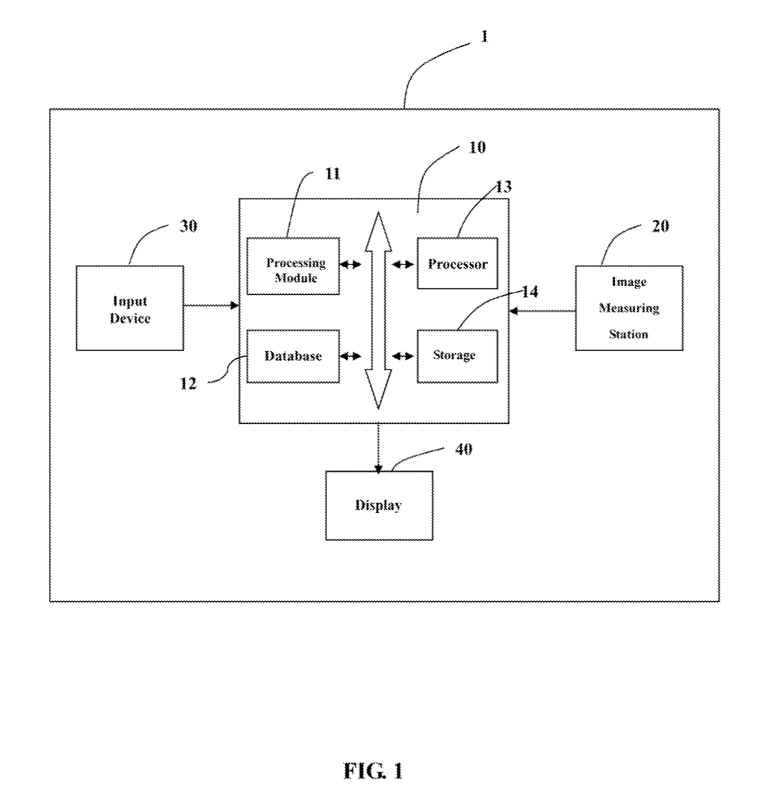

FIG. 1 is the block diagram of an exemplary embodiment of an image measuring device for calibration test of the present disclosure. The electronic device 1 includes a host device 10, an image measuring station 20, an input device 30 and a display 40. The host device 10 includes a processing module 11, a database 12, a processor 13 and a storage 14. The processing module 11 is stored in the storage 14. The processor 13 controls the processing module 11, the database 12 and the storage 14 to execute the functions described below. In the exemplary embodiment, the electronic device 1 is an image measuring device for production calibration test in massive production process.

The electronic device 1 is generally controlled and coordinated by an operating system, such as UNIX, Linux, Windows, Mac OS, an embedded operating system, or any other compatible system. Alternatively, the electronic device 1 may be controlled by a proprietary operating system. Typical operating systems control and schedule computer processes for execution, perform memory management, provide file system, networking, and I/O services, and provide a user interface, such as a graphical user interface (GUI), among other tasks.

In the exemplary embodiment, the image measuring station scans a production object and generates an image of the production object. The host device 10 acquires the image and displays the image in the display 40 after processing. A tool list including a measuring tool column and a parameters tool column is presented in the display 40 as graphical objects, such as icons, through the graphical user interface. In one exemplary embodiment, the measuring column includes tool icons, such as an auto point search icon, an auto line search icon, an auto curve search icon, a manual positioning icon and an edge-finding icon. The parameters tool column includes tool icons for adjusting image characters, such as icons graphically presenting rotating, flipping or nudging operations.

The processing module 11 controls the image measuring station 20 to scan the production object and generate the image. The processing module 11 also transforms the images as a group of character parameters and stores the parameters in the database 12. The database 12 is stored in the storage 14. The processing module 11 further compares the character parameters of the production object with a group of basic parameters predefined by user. The basic parameters are also stored in the storage 14. The basic parameters include predefined size and tolerance of the production object. User decides what kinds of characters are included in the group of character parameters through selecting measuring tools of the tool list by the graphical user interface.

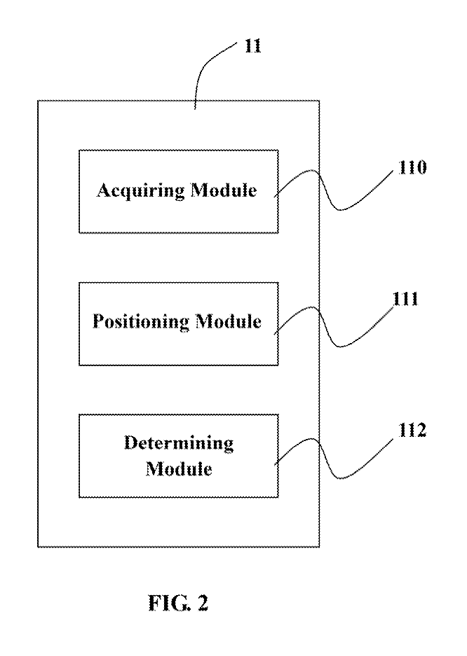

FIG. 2 is a block diagram of the processing module 11 of the present disclosure. The processing module 11 includes an acquiring module 110, a positioning module 111 and a determining module 112. The acquiring module 110 acquires the image of the production object from the host device 10. The acquiring module 110 transforms the images as the group of character parameters and stores the parameters in the database 12. In one exemplary embodiment, the character parameters include the edge of the production object. User selects a measuring tool for detecting edge of the production object and selects a close area for processing through the graphical user interface. The acquiring module 110 detects the variance of gray degree of the image of the production object and chooses the pixels of the image with variance stronger than a threshold value as the edge of production object.

The group of basic parameters includes parameters of basic coordinate planes and basic edge images corresponding to each production object. The coordinate plane is a coordinate system in which the coordinates of a point are its distances from a set of perpendicular lines that intersect at an origin, such as two lines in a plane or three in space. The positioning module 111 determines the type of the production object in accordance with basic edge images of the basic parameter. The positioning module 111 positions the coordinate plane of the image of the production object in accordance with the coordinate planes of the basic parameter. Then, the positioning module calibrates the proportion of the edge of the production object to be equal to the edge parameter in the basic parameter through the coordinate plane.

The determining module 112 compares the edge of the image of the production object with the corresponding parameters in the group of basic parameters to determine whether the difference between two parameters is over the tolerance predefined in the group of basic parameters. When the difference is not beyond the tolerance, the host device 10 sends a pass signal to the image measuring station 20 to pass the production object as a qualified production. When the difference is beyond the tolerance, the host device 10 sends a failure signal to the image measuring station 20 to fail the production object as a disqualified production and pass it into a modifying process.

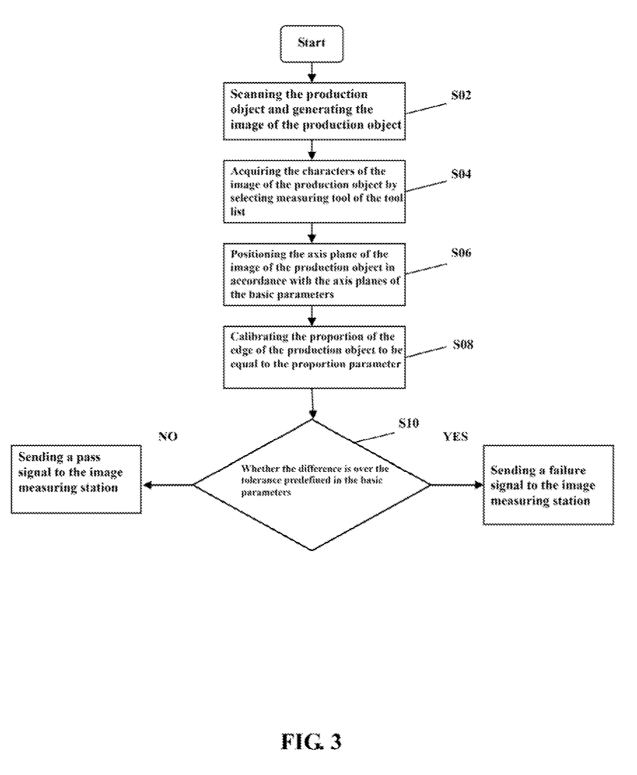

FIG. 3 is a flowchart of an exemplary embodiment of a measuring method for calibration test of the present disclosure.

In block S02, the image measuring station 20 scans the production object and generates the image of the production object.

In block S04, the acquiring module 110 acquires the characters of the image of the production object by selecting measuring tool of the tool list. The acquiring module 110 acquires the edge of the production object in the image through the graphical user interface.

In block S06, the positioning module 111 positions the coordinate plane of the image of the production object in accordance with the coordinate planes of the basic parameter.

In block S08, the positioning module calibrates the proportion of the edge of the production object to be equal to the proportion parameter in the basic parameter through the coordinate plane.

In block S10, the determining module 112 compares the edge of the image of the production object with the corresponding parameters in the group of basic parameters to determine whether the difference between two parameters is over the tolerance predefined in the group of basic parameters. When the difference is not beyond the tolerance, the host device 10 sends a pass signal to the image measuring station 20 to pass the production object as a qualified production. When the difference is beyond the tolerance, the host device 10 sends a failure signal to the image measuring station 20 to fail the production object as a disqualified production and pass it into a modifying process

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. An image measuring device comprising a storage and a processor, comprising:
an acquiring module that acquires an image of a production object by scanning the production object;
a positioning module that positions the image of the production object in a coordinate plane according to predefined parameters and acquiring the edge of the image of the production object; and
a determining module that determines whether the difference between the positioned image and the predefined parameters is over a tolerance, wherein the acquiring module, the positioning module and the determining module are stored in the storage and controlled by the processor.

2. The image measuring device of claim 1, wherein the positioning module further calibrates the image of the production object to meet a proportion predefined in the predefined parameters.

3. The image measuring device of claim 1, wherein the acquiring module further acquires a group of parameters by selecting a measuring tool through a graphical user interface.

4. The image measuring device of claim 3, wherein the group of parameters comprises the edge of the production object.

5. The image measuring device of claim 3, wherein the measuring tool is selected from the group of a point search tool, an auto line search tool, an auto curve search tool, a manual positioning tool and an edge-finding tool.

6. An image measuring method for calibration test, comprising:
acquiring an image of a production object by scanning the production object;
positioning the image of the production object in a coordinate plane according to predefined parameters and acquiring the edge of the image of the production object; and
determining whether the difference between the positioned image and the predefined parameters is over a tolerance.

7. The image measuring method of claim 6, further comprising:
calibrating the image of the production object to meet a proportion predefined in the predefined parameters

8. The image measuring method of claim 6, further comprising:
acquiring a group of parameters by selecting a measuring tool through a graphical user interface.

9. The image measuring method of claim 6, wherein the group of parameters comprises the edge of the production object.

10. The image measuring method of claim 6, wherein the measuring tool is selected from the group of a point search tool, an auto line search tool, an auto curve search tool, a manual positioning tool and an edge-finding tool.
